(19) United States
(12) Patent Application Publication
(10) Pub. No.: US 2005/0127006 A1
(43) Pub. Date: Jun. 16, 2005

(54) Method and apparatus for increasing the capacity of ion exchange resins

(76) Inventor: Donald M. Stromquist, Bountiful, UT (US)

Correspondence Address: MALLINCKRODT & MALLINCKRODT, 10 EXCHANGE PLACE, SUITE 510, SALT LAKE CITY, UT, 84111, US

(21) Appl. No.: 10/939,709

(22) Filed: Sep. 13, 2004

Related U.S. Application Data
(63) Continuation-in-part of application No. 10/733,557, filed on Dec. 11, 2003.

(51) Int. Cl. B01J 20/34

(52) U.S. Cl. 210/670; 502/25; 502/22; 210/673

(57) ABSTRACT

The ion exchange capacity of resin in an ion exchange column can be increased by applying a magnetic field to the resin while the ion exchange procedure takes place. The magnetic field may be generated in a variety of ways. Apparatus for practicing the invention may include permanent magnets, either stationary or movable, or an electromagnet or electromagnets arranged with respect to an ion exchange column to create a magnetic field in the resin in the column. When using an electromagnet, magnetic material, such as a cast iron rod or bar, is placed in the resin bed to direct and concentrate the magnetic field in the resin.

### RELATED APPLICATIONS

This is a continuation-in-part of copending application Ser. No. 10/733,557, filed Dec. 11, 2003, entitled Method and Apparatus for Increasing the Capacity of Ion Exchange Resins.

### BACKGROUND OF THE INVENTION

1. Field

The invention is in the field of ion exchange.

2. State of the Art

Ion exchange resins are used in numerous ion exchange processes, such as water softening and water desalinization. The process works by passing material to be treated over or through a bed of the ion exchange resin. As the material contacts the ion exchange resin, particular ions to be removed from the material bind to the resin. The result is that the treated material leaving the ion exchange apparatus has a lesser amount of the particular ionic components than the material entering the apparatus. During treatment, the ion exchange resin becomes loaded with the ions binding to the resin. As the resin becomes more loaded with these bound components, the effectiveness of the ion exchange drops. Eventually the resin becomes so saturated with the ions from the material that the ion exchange process becomes ineffective, the ions to be removed are not removed, and the resin is considered “spent.” The “spent” resin has to be regenerated, usually by elution, in order to restore the resin's capacity to again bind the desired components before further ion exchange can take place.

For Example, ion exchange columns are used for water softening. Hard water has Ca++ and Mg++ ions therein which make it “hard.” A typical water softener uses NaCl to remove the Ca++ and Mg++ ions from the water by passing the water through a bed of ion exchange resin where the resin carries Na ions. The resin exchanges its Na ion for the Ca and Mg ions in the water. After performing this operation for a certain amount of time, the resin becomes loaded with Ca++ and Mg++ ions and its Na ions become depleted. The resin is so full of ions taken from the treated material and depleted in its own ionic component that ion exchange can no longer occur. Once this happens either new resin must be used or the resin must be regenerated before the apparatus will function again.

Regeneration of the “spent” resin involves treating the “spent” resin with a regenerant, generally sodium chloride, hydrochloric acid, or sulfuric acid, which reverses the process and exchanges the ions which have been removed from the material treated and built up on the resin with ions of the type originally on the resin. Thus, for the water softener example, the spent resin is treated with NaCl in the form of strong salt water so that the exchange process is reversed and the Ca++ and Mg++ ions on the spent resin are removed from the resin and replaced with Na ions. The effectiveness of the regeneration process depends upon the strength and amount of regenerant used. However, regenerants have a cost which adds to the cost of the ion exchange process and have to be balanced with overall process costs. Thus, the regenerant is carefully used in volume and weight to provide an effective resin capacity for the process concerned along with most effective overall process costs.

Since the effectiveness of an ion exchange process is tied to the ion exchange capacity of the resin, i.e., the capacity of the resin to exchange and thereby remove the ions to be removed from the material being treated before the resin becomes spent and has to be regenerated, increasing the ion exchange capacity of the resin in a given ion exchange process in an economic manner will increase the effectiveness of that ion exchange process.

### SUMMARY OF THE INVENTION

According to the invention, the ion exchange capacity of ion exchange resin can be increased by applying a magnetic field to the resin while the ion exchange procedure takes place. The increased resin capacity makes the resin more efficient as more material can be treated by the resin before the resin requires regeneration. The apparatus needed is simple in design and only requires that a magnetic field be applied to any given nonmagnetic ion exchange column, such as ion exchange columns made of plastic or glass. The ion exchange column is used to hold the resin as it contacts the material to be treated. A variety of magnetic devices may be used and have been used successfully including stationary magnets taped to the ion exchange column, magnets that rotate around the column, and an A.C. and/or pulsed D.C. current applied to a wire wrapped around the ion exchange column. A rod of magnetic material, such as cast iron, can be placed in the column to concentrate the magnetic field generated in the wire coil around the column. Some minimal magnetic strength appears to be required before a practical increase in ion exchange capacity is observed, but currently this minimum level is unknown.

### THE DRAWINGS

In the accompanying drawings, which show the best mode currently contemplated for carrying out the invention:

FIG. 1 is a vertical section of an ion exchange column positioned in a tube with wire wrapped around it to create a magnetic field in the ion exchange column in order to increase ion capacity;

FIG. 2, a vertical section similar to that of FIG. 1, but showing the wire wrapped around the ion exchange column;

FIG. 3, a circuit diagram of a signal generation circuit used in testing the invention;

FIG. 4, a graph showing test results using an electromagnet to increase resin capacity;

FIG. 5, a vertical section of an ion exchange column having a passive magnetic source that is rotated around the ion exchange column;

FIG. 6, a graph showing results of tests with the apparatus using a passive magnet being rotated around the ion exchange column;

FIG. 7, a vertical section of an apparatus using stationary passive magnets placed around an ion exchange column that increases the ion exchange capacity of the resin;

FIG. 8, a transverse section taken on the line 8-8 of FIG. 7;

FIG. 9, a transverse section similar to that of FIG. 8, but showing a different arrangement of magnets;

FIG. 10, a graph of the test run of an apparatus using stationary passive magnets to increase the ion exchange capacity of a resin; and

FIG. 11, a transverse section similar to that of FIG. 9, showing the air gaps between the magnets and the ion exchange tube filled with a filler material.

### DETAILED DESCRIPTION OF THE ILLUSTRATED EMBODIMENTS

Ion exchange columns are used in a variety of processes, such as water softening and water desalinization. Ion exchange works by passing material that needs to be treated, like water, over a resin. The resin exchanges its ionic component with an ion in the material to be treated. For example, a typical water softener uses NaCl to remove Ca++ and Mg++ from the water by exchanging its Na ion for the Ca and Mg ions in the water. After performing this operation for a certain amount of time, the resin becomes loaded. The resin is so full of ions taken from the treated material and depleted in its own ionic component that ion exchange can no longer occur. Once this happens either new resin must be used or the resin must be regenerated before the apparatus will function again.

The inventor has found that applying a magnetic field to the ion exchange column during the exchange process will increase the binding capacity of the resin, increasing the amount of time the ion exchange column can operate before requiring regeneration. The invention comprises applying a magnetic field to the resin in the ion exchange column during the ion exchange procedure. The invention works with both cathodic and anodic resins. The invention can also increase the capacity of both types of resins when combined into a single mixed bed apparatus. The magnetic field can be generated with an electromagnet or with permanent magnets. An electromagnet can be formed by wrapping magnet or other wire around a nonmagnetic ion exchange column, such as a plastic or glass tube containing ion exchange resin, or by placing permanent magnets around a nonmagnetic ion exchange column. The permanent magnets may be secured to the column in stationary manner or may be mounted for rotation around the column.

A minimum threshold of magnetic force appears to be needed, but the exact level of this force has not been determined. Several initial preliminary tests indicated no benefit from a small magnetic field surrounding the resin in an ion exchange column during the ion exchange procedure. In one test, a twelve inch long, 1/16 inch thick, two inch inside diameter steel tube was lined with five sets, ten total, small permanent magnets. A one inch diameter acrylic tube filled with cation resin was inserted into the metal tube with the magnets between the metal tube and the acrylic tube. When sea water was passed through the resin, no increase in cation bonding capacity was observed.

In a second test, the steel tube of the first test, with interior permanent magnets still in place, was wrapped with high temperature resistant paper. The paper was then wrapped with 5000 wraps of twenty eight gage copper magnet wire over its twelve inch length. The wire was held by two four inch diameter wood discs at each end of the tube. The wire was insulated with wraps of high temperature resistive insulating tape. The ends of the magnet wire were connected to a plug to be plugged into a 110 volt AC outlet. A fifteen inch long, one and five eights inch diameter acrylic tube was inserted into the steel tube and filled with IR-120 which is a cation resin from Rohm & Haas. Once again, no beneficial increase of the resin's capacity was observed when sea water was run through the apparatus with the coil plugged into a 110 volt AC outlet. Use of a rectifier to provide 110 volt and 220 volt DC was also of no use. Additional tests with wire wrapped around a metal tube were also unsuccessful, probably because any magnetic field generated by the wire windings was blocked by the metal tube from influencing the ion exchange column within the metal tube.

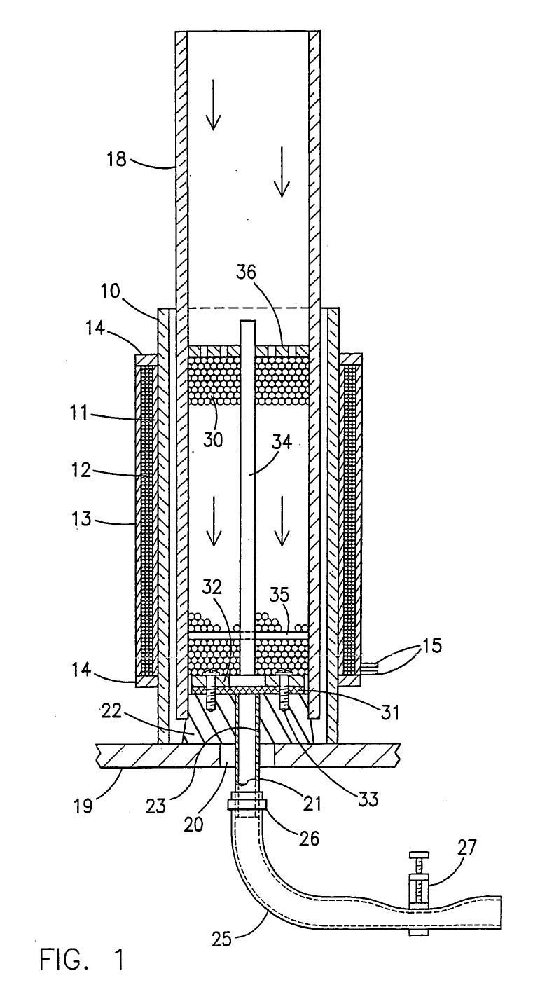

In order to further test the idea of increasing the capacity of ion exchange resin by providing a magnetic field around the resin during the ion exchange process, a test apparatus as shown in FIG. 1 was built. The apparatus shown in FIG. 1 includes a nonmagnetic tube 10, such as a plastic or glass tube, wrapped with heat resistant tape 11, then wrapped with magnet wire 12, which is then wrapped again with an outer coating of heat resistant tape 13. The length of wrap along the length of tube 10 is established by discs 14 of a nonconductive material such as wood or plastic. Leads 15 of magnet wire extend from the windings for connection to a source of power. An ion exchange column 18 is positioned in tube 10. Both tubes 10 and ion exchange column 18 are supported by a table or other support surface 19 having a cutout 20 for outlet tubing 21. Ion exchange column 18 is made of nonmagnetic material such as plastic or glass. A rubber stopper 22 closes the bottom of tube 18 and has a hole 23 drilled therethrough which frictionally holds substantially rigid outlet tube 21. Flexible plastic tubing 25 is connected to the end of outlet tube 21 and may be secured, if necessary or desirable, by clamp 26. An adjustable clamp 27, such as a screw clamp, is positioned toward the end of flexible tubing 25 and is used to control flow of liquid through tubes 25 and 21 from and to the bottom of ion exchange column 18.

Ion exchange resin 30 fills ion exchange column 18, preferable no more than about half way, but extends through the height of the wire windings 12. A screen or mesh material 31, such as a nylon mesh, covers hole 23 to prevent the ion exchange resin from flowing out of the bottom of the column. The screen or mesh material 31 may be positioned over the end of stopper 22 and sandwiched between the sides of the stopper and the column to hold it in place, or, as illustrated, a washer 32 may be secured to the top of stopper 22 by screws 33 to secure the screen or mesh material in place over hole 23.

A core 34 of nonmagnetizable magnetic material, such as cast iron, is positioned in the center of ion exchange column 18 to extend through the ion exchange resin 30. Core 34 is centered in the bottom of the ion exchange column by a nonmagnetic rod 35 extending through core 34 and at the top of the core by either a similar nomagnetic rod, or if the top of the rod is above the level of the resin, by a centering disc 36. A centering rod could be used at the top in this case also, but the centering disc, which is perforated and positioned above the top of the resin bed, serves the additional purpose of distributing the material added to the column for treatment and reducing turbulence at the top of the bed when the material is added. When a centering disc is not used, such as when the top of the rod is in the resin, a similar disc is generally provided above the resin to reduce turbulence at the top of the bed when the material is added. With the embodiment illustrated, the ion exchange column 18 can be inserted in the tube 10 having the windings 12, and the ion exchange column can be removed and easily replaced when desired.

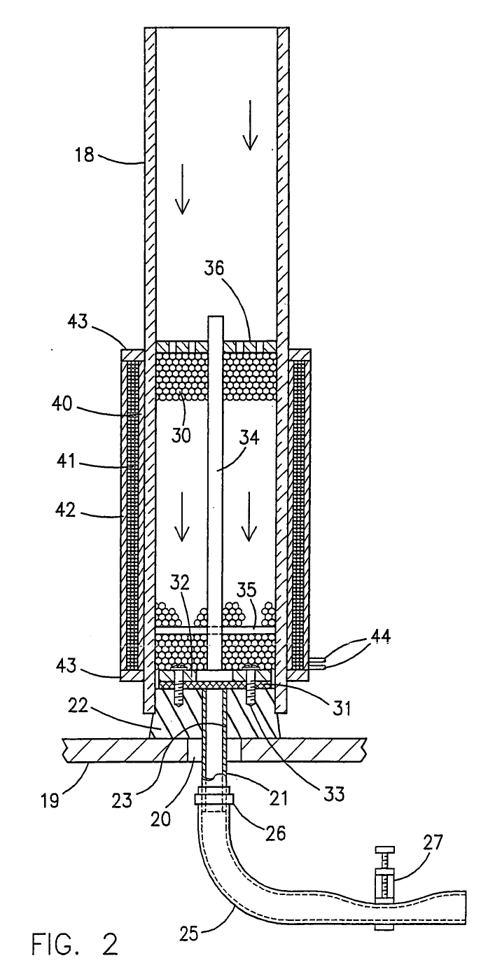

Rather than a separate tube 10 for the windings 12, windings 12 could be placed directly around the ion exchange column 18. FIG. 2 shows this embodiment where all reference numbers for the ion exchange column are the same, but heat resistant tape 40 is wrapped directly around the ion exchange column, magnet wire 41 is then wrapped around the column, which is then wrapped again with an outer coating of heat resistant tape 42. Again, the length of wrap along the length of ion exchange column 18 is established by discs 43 of a nonconductive material. Leads 44 of magnet wire extend from the windings for connection to a source of power.

The dimensions of the apparatus shown in FIGS. 1 and 2 can vary considerably. For experimental and test purposes, ion exchange column 18 may be between one and one half to two inches in diameter, and up to forty eight inches long, and may be made of various plastic materials, such as acrylic or PVC, or of glass materials, such as pyrex. Tube 21 may be a one quarter inch diameter glass or plastic tube with three eights inch diameter flexible rubber latex hose attached as tube 25. Tube 10 may also be of a plastic material, such as acrylic or PVC, or of glass, such as pyrex, but usually will not be as long as the ion exchange tube. Twenty three to twenty eight gage magnet wire has been found satisfactory for the wire windings with between about 5,000 and 10,000 windings over a length up to about twelve inches. The core can be a variety of metal bars with cast iron currently being preferred. The cast iron should be coated to prevent heavy metal from the cast iron corroding off into solution with the hydrochloric acid used as a resin regenerant. Heavy metals in the solution could poison the resin. A fifty-fifty mix of spar varnish and mineral spirits has been found a satisfactory coating for the cast iron core. The core can be a rod up to about three quarters of an inch in diameter or a bar about one quarter inch thick by three quarters inch wide. The core preferably extends through the height of the resin bed but works satisfactorily even when extending through only a portion of the bed. A core length of twelve and one half inches is generally satisfactory with a resin bed depth of about twelve inches.

When power is connected between the coil leads 15, current flows through the coils 12 and a magnetic field is generated. The magnetic field extends through the resin 30 within the coils 12 with the metal core 34 concentrating the magnetic field in the resin bed. Thus, the resin in the resin bed is under the influence of a magnetic field. The coils can be energized by various signals from the standard 110 volt, sixty Hertz AC signal from a wall outlet to various other AC and DC signals from a variety of signal generators.

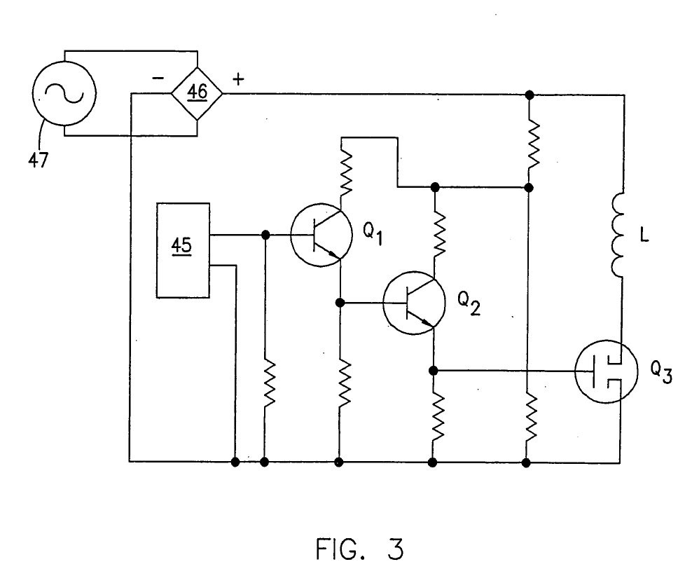

A signal generation circuit used to vary the signal applied to electromagnet L, FIG. 3, formed by the coils around the ion exchange column as shown in FIGS. 1 and 2, includes a signal generator 45, such as a Slenco #FG 500 Function Generator, with output connected through transistors Q1 and Q2 to the gate of an N-channel MOSFET transistor Q3, such as an NTE #2397 MOSFET. The wire coil L is connected in series with MOSFET Q3 between the positive and negative terminals of a DC voltage source, here the DC terminals of full wave rectifier 46 connected to a standard 110 volt wall outlet indicated by AC source 47. Various voltage dividing and bias resistors are also provided in the circuit in normal manner. The function generator 45 can produce sine, square, and triangle waves of one, two, or three volts adjustable in frequency from 0 to 10,000 Hertz. With the circuitry shown, two volt signals from the generator were used. The function generator thus adjusts the nature and frequency of the signal applied across the coil L. Sine waves of frequencies between about 500 to 750 Hertz were found to work best.

Various experiments have been performed with the apparatus shown in FIG. 1. For each experiment, except as indicated, the starting resin in the column was resin that had been regenerated in the column in a set way within recommended specifications of the resin manufacturer.

### EXAMPLE 1

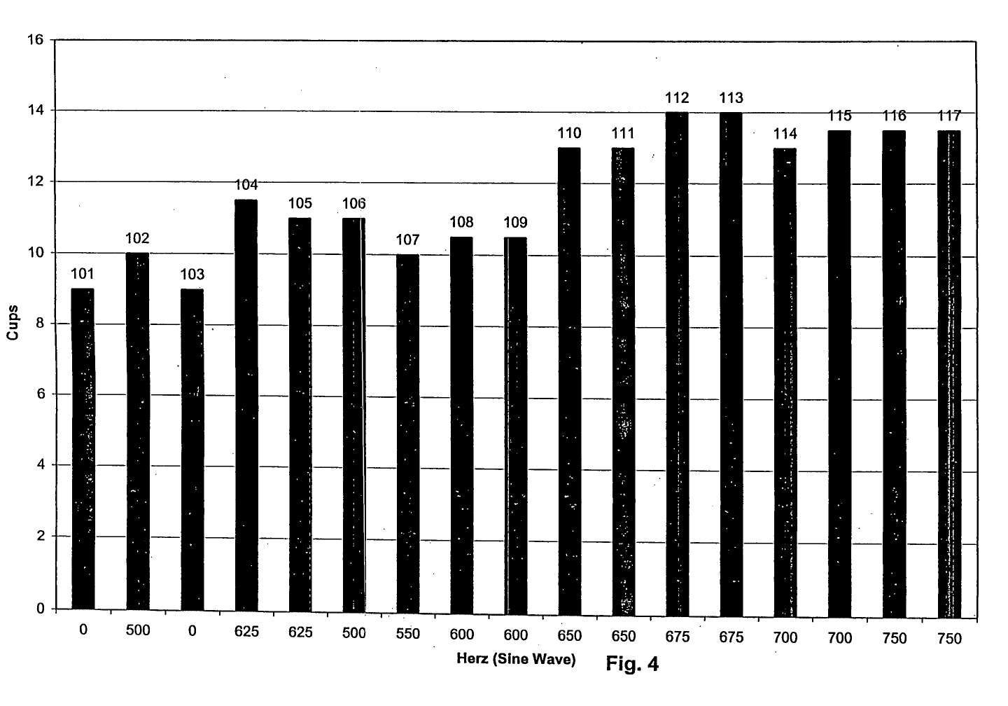

An apparatus substantially as shown in FIG. 1 was used with an upright pyrex tube of 1¾ inch OD and 1½ inch ID as the ion exchange column. About 300 grams of Rohm & Haas IR-120 cation resin formed about an eighteen inch resin bed in the column. The resin was regenerated prior to the test using forty eight grams of 37% HCl diluted with 250 grams of distilled water which culminates in an acid strength of about 5% to about 6% contained HCl. This is the manufacturer recommended regeneration procedure. The regeneration extended over thirty three minutes and was followed with a nineteen minute rinse with 460 ml distilled water. Prior to regeneration, the resin bed was backwashed by the introduction of distilled water from the bottom of the column through tube 21 until the water passing upwardly through the resin bed neared the top of the column. The flow of water was stopped, the resin was allowed to settle, and dormant water was siphoned off from the top of the column to near the top of the resin. Backwashing of the resin bed accomplishes loosening, expansion, and re-classifying of the resin which permits more uniform distribution of fluid in the subsequent downflow operations of regeneration, rinsing, and ion exchange. A rubber disc was placed in the column just over the top of the resin to reduce possible turbulence in the resin when regenerant liquid, rinse liquid, or sample was added to the column. No rod was present in the resin and no magnetic field was generated around the column. After the rinse, with distilled rinse water still covering the resin to the top of the resin bed, a sample of San Francisco Bay water was added to the top of the column and run through the column. The flow rate was adjusted to about eight ounces of effluent ever one to three minutes. The pH of the sample emerging from the column was tested for every eight ounces and the resin was deemed to be exhausted when the pH of the effluent reached a pH about four to four and one half. Multiple runs were made to ensure a repetitive value for this base measurement. This test showed between nine and ten cups of sample could be treated by the resin in the column before the resin was exhausted. This result is shown as the first bar, labeled 101, in the graph of FIG. 4.

For the second run, the coil made up of 10,000 wraps of number twenty three magnet wire around a two inch outer diameter pyrex tube, was energized with the function generator of the circuitry of FIG. 3 set to produce a two volt sine wave at a frequency of 500 hertz. No iron bar was in the resin. The resin had been backwashed, regenerated and rinsed as described for the first run, with a twenty six minute regeneration and twenty three minute rinse. San Francisco Bay water was again used as the sample. The test run showed that the resin became exhausted between about ten and ten and one half cups of sample slightly better than the previous run. This is shown by the second bar, labeled 102, in the graph of FIG. 4. This showed a slight advantage with the magnetic field applied.

The third run was similar to the first run without the metal bar and without any magnetic field generated by the coil. However, 300 grams of Dow HCR cation resin was used rather than the 300 grams of Rohm and Haas IR-120 resin, and the sample treated was San Francisco ocean water rather than San Francisco Bay water. The regeneration time prior to the sample run was nineteen minutes with a fourteen minute rinse. The results were about the same as the first run with the test showing between nine and ten cups of sample could be treated by the resin in the column before the resin was exhausted. This result is shown as the third bar, labeled 103, in the graph of FIG. 4.

The fourth run used the coil made up of 10,000 wraps of number twenty three magnet wire around a two inch outer diameter pyrex tube as used in run two. The coil was energized with the function generator of the circuitry of FIG. 3 set to produce a two volt sine wave at a frequency of 625 hertz. Dowex HCR-W2 cation resin was used which is equivalent to the Dow HCR resin used in run three. Regeneration extended for about twenty seven minutes and rinse lasted about twenty three minutes. However, even though regeneration and rinse steps were performed as described for the prior runs, the resin was new resin. A milled cast iron twelve and one quarter inch long by three quarter inch wide by one quarter inch thick flat rod was placed in the center of the column at the bottom of the column and extending through the bottom twelve and one quarter inches of the resin bed. San Francisco ocean water was used as the sample. The test run showed that the resin became exhausted between about eleven and one half to about twelve cups of sample, significantly better than previous runs. This is shown by the fourth bar, labeled 104, in the graph of FIG. 4. This showed a significant increase in resin capacity with the magnetic field applied and the iron bar in the resin to focus the magnetic field in the resin.

The fifth run was the same as the fourth run except that the resin was no longer new. It was regenerated over about twenty five minutes with a rinse of about nineteen minutes. The first seventy five ml. of effluent was discarded prior to starting testing to allow the rinse water at the start of the run to flow out of the column and ensure that the sample was being tested. This test run showed that the resin became exhausted between about eleven and eleven and one half cups of sample, slightly less than the previous run. This is shown by the fifth bar, labeled 105, in the graph of FIG. 4. The difference between this and the previous run might be accounted for because the resin was new in the previous run.

The sixth run was the same as the fifth run, but with a 500 hertz sine wave applied to the coil. The resin was regenerated over about twenty one minutes with a rinse of about twenty two minutes. This test run showed that the resin became exhausted at about eleven cups of sample, about the same as run five. This is shown by the sixth bar, labeled 106, in the graph of FIG. 4.

The seventh run was the same as the sixth run, but with a 550 hertz sine wave applied to the coil. This test run showed that the resin became exhausted at about ten to ten and one half cups of sample, less than that for run six. This is shown by the seventh bar, labeled 107, in the graph of FIG. 4.

The eighth run was the same as the sixth run, but with a 600 hertz sine wave applied to the coil. The resin was regenerated over about thirty minutes with a rinse of about twenty minutes. This test run showed that the resin became exhausted at about ten and one half to eleven cups of sample. This is shown by the eighth bar, labeled 108, in the graph of FIG. 4.

The ninth run was similar to the eighth run using the equivalent Dow HCR cation resin, but with a twelve and three quarter inch long, seven sixteenth inch round rod rather than the flat rod in the resin bed. Backwash was done twice. Regeneration took about twenty five minutes and rinse took about nineteen minutes. The results were the same as for run eight indicating no difference between the round and flat rods. This is shown by the ninth bar, labeled 109, in the graph of FIG. 4.

The tenth run was similar to the ninth run but with the flat cast iron rod of previous runs and using a 650 hertz sine wave applied to the coil. Regeneration took about twenty two minutes and rinse took about twenty four minutes. This test run showed that the resin became exhausted at about thirteen to thirteen and one half cups of sample. This is shown by the tenth bar, labeled 110, in the graph of FIG. 4.

The eleventh run was the same as the tenth run with a regeneration time of about twenty minutes and rinse time of about twenty two minutes. This test run showed that the resin became exhausted at about thirteen to thirteen and one half cups of sample, the same as with the previous run. This is shown by the eleventh bar, labeled 111, in the graph of FIG. 4.

The twelfth run used a one and five eights inch inside diameter pyrex column with a 675 hertz sine wave applied to the coil. Regeneration took about twenty two minutes and rinse took about twenty two minutes. This test run showed that the resin became exhausted at about fourteen to fourteen and one half cups of sample. This is shown by the twelfth bar, labeled 112, in the graph of FIG. 4.

The thirteenth run was the same as the twelfth run with a 675 hertz sine wave applied to the coil. Regeneration took about thirty minutes and rinse took about eighteen minutes. This test run showed that the resin became exhausted at about fourteen to fourteen and one half cups of sample, the same as for the prior run. This is shown by the thirteenth bar, labeled 113, in the graph of FIG. 4.

The fourteenth run was the same as the thirteenth but with a 700 hertz sine wave applied to the coil. Regeneration took about twenty four minutes and rinse took about seventeen minutes. This test run showed that the resin became exhausted at about thirteen to thirteen and one half cups of sample. This is shown by the fourteenth bar, labeled 114, in the graph of FIG. 4.

The fifteenth run was the same as the fourteenth. Regeneration took about twenty three minutes and rinse took about twenty seven minutes. This test run showed that the resin became exhausted at about thirteen and one half to about fourteen cups of sample. This is shown by the fifteenth bar, labeled 115, in the graph of FIG. 4.

The sixteenth run was the same as the fifteenth but with a 750 hertz sine wave applied to the coil. Regeneration took about twenty minutes and rinse took about twenty three minutes. This test run showed that the resin became exhausted at about thirteen and one half to about fourteen cups of sample. This is shown by the sixteenth bar, labeled 116, in the graph of FIG. 4.

The seventeenth run was the same as the sixteenth. Regeneration took about twenty five minutes and rinse took about nineteen minutes. This test run showed that the resin became exhausted at about thirteen and one half to about fourteen cups of sample. This is shown by the seventeenth bar, labeled 117, in the graph of FIG. 4.

As indicated by the results of Example 1, the presence of an electromagnetic field around the ion exchange column and a bar of magnetic material in the resin to direct and concentrate the magnetic field in the resin, is effective to increase the ion exchange capacity of the resin. While the magnitude of the capacity increase varied with factors such as the frequency of the sine wave used to create the magnetic field, significant increases in capacity occurred at all frequencies tested. Thus, without the magnetic field present, about seventy two ounces of water could be treated with the resin. However, with the magnetic field present along with the metal bar, up to one hundred and twelve ounces of water could be treated with the same amount of resin and using the same resin regeneration procedure. This was a significant 55% increase in ion exchange capacity of the resin. The variation in regeneration and rinse times, due mainly to the nonrepeatable flow rates through the column during regeneration and rinse, did not appear to influence the results. This would be expected as the regeneration time should not matter as long as it is enough to regenerate the resin. Various other tests indicated that a sine wave appeared to work better than a square or triangle wave and that various types of metal bar could be used with about the same results.

### EXAMPLE 2

Similar tests were performed as in Example 1 only using an anion resin instead of a cathodic one. Further, the apparatus used was that shown in FIG. 2 with 10,000 wraps of number twenty three magnet wire wrapped along about fifteen inches of a two inch outside and one and three quarter inch inside diameter ion exchange column. Regeneration was accomplished using 35 grams of 50% liquid NaOH Caustic soda. Some of the anions tested include Dowex Marathon A-OH form, Dowex Marathon WBA (a weak anion exchanger), and Dowex 550-A (a strong anion resin). The effect of the magnetic field is well illustrated by the results of the test performed using Dowex Marathon WBA. The San Francisco ocean water run without any magnetic field being applied resulted in eighty ounces of water treated before reaching the resin capacity. With a 625 Hz sine wave applied to the coil and a cast iron bar in the resin, the anion resin was able to process one hundred and twenty ounces of water before reaching capacity. This was a significant 50% increase in ion exchange capacity.

### EXAMPLE 3

Similar results are reached when a cation resin and an anion resin are mixed together to form a mixed bed in the column. Rohm & Haas cation IR-120 was regenerated individually and then mixed with anion Dowex 55A-OH, which had also been regenerated individually. Without the magnetic field, sixty eight ounces of San Francisco ocean water were treated before the capacity of the resins was reached. When a 675 Hz sine wave was used to create the magnetic field, ninety six ounces of water passed through before the capacity of the resin was reached. This is a significant 41% increase in capacity.

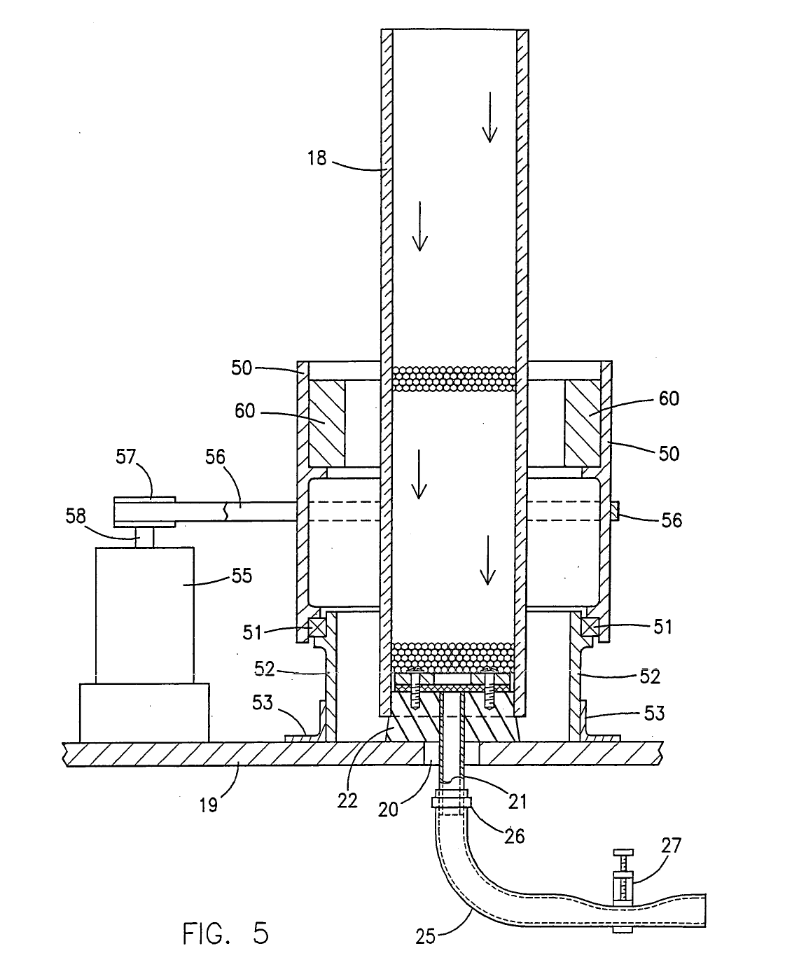

An alternate apparatus for creating a magnetic field in an ion exchange resin bed is shown in FIG. 5. The ion exchange column is shown as the same column used in FIGS. 1 and 2 and is numbered similarly. In this embodiment, however, rather than an electromagnet to generate the magnetic field, the magnetic field is generated by permanent magnets surrounding the column. The permanent magnets are arranged so they can be rotated around the tube. Thus, the ion exchange column described for FIG. 1 is inserted into a rotating drum 50, which was a motor housing with magnets therein, mounted for rotation by ball bearing race 51 mounted on base 52. Base 52 is secured to mounting board 19 by angle irons 53 which are attached to both the base and mounting board by screws. A motor 55 is mounted on mounting board 19 and a pulley belt 56 extends from pulley 57 attached to motor shaft 58 and extends around drum 50. Operation of motor 55 causes rotation of rotating drum 50. The speed of rotation of motor 50 can be controlled by a rheostat electrically connected to motor 55 in normal manner. Permanent magnets 60 are mounted in drum 50. The magnets 60 shown are semicircular through 180° so that two magnets 60 mounted end-to-end in drum 50 will completely surround ion exchange column 18. Several rows of these magnets could be mounted in drum 50 to extend through the height of the resin bed, although only a single row were used for the following examples.

### EXAMPLE 4

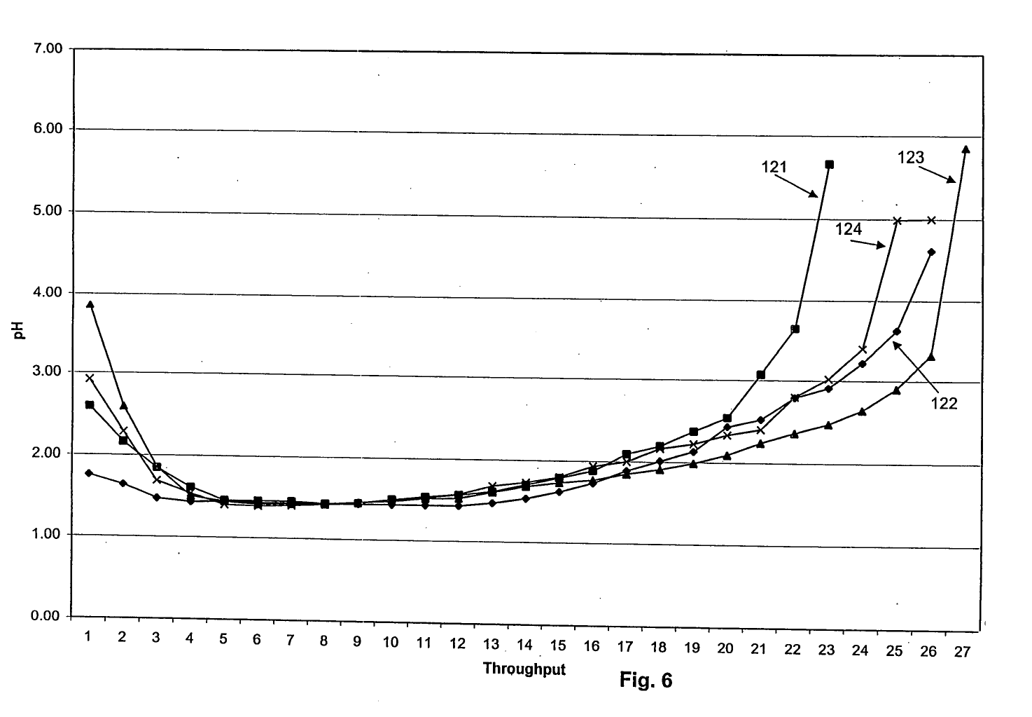

Several test runs were made using the apparatus of FIG. 5. A two and three quarter inch inside diameter, three inch outside diameter, tube serving as the ion exchange column was loaded to an 11 inch depth with Dow HCR cation resin. The resin was backwashed with distilled water, regenerated using 50.9 grams of 37% HCl diluted with 250 grams of distilled water, and then rinsed with two cups of distilled water. The results of a base run using sea water with the resin filled tube outside the drum so not under the influence of a magnetic field is shown in FIG. 6 as line 121. The resin was considered exhausted when the pH of the effluent sea water went above four. FIG. 6 shows that between twenty two and twenty three cups, or about 176 oz. of sea water passed through the resin before capacity was reached.

The resin filled tube was inserted into the drum holding the magnets as shown in FIG. 5. The drum was not rotated so a passive, non-moving magnetic field was created around the column. Here the resin successfully passed between twenty five and twenty six cups, or about 203 oz. of sea water before becoming loaded as shown by line 122 in FIG. 6. With motor 55 operating to rotate the drum and magnets therein at somewhere between about fifty two and one hundred rpm, between twenty six and twenty seven cups, or about 208 oz. of sea water were treated before exhausting the resin as shown by line 123, FIG. 6. With a higher rotation rate, motor 55 operating at full speed but with the rotation rate unknown, between twenty four and twenty five cups, or about 196 oz. of sea water were treated before exhausting the resin. This is shown by line 124, FIG. 6. This example shows that the magnetic field around the ion exchange column significantly increased the ion exchange capacity of the resin with the nonmoving field and slowly rotating field having a larger effect than a faster rotating field.

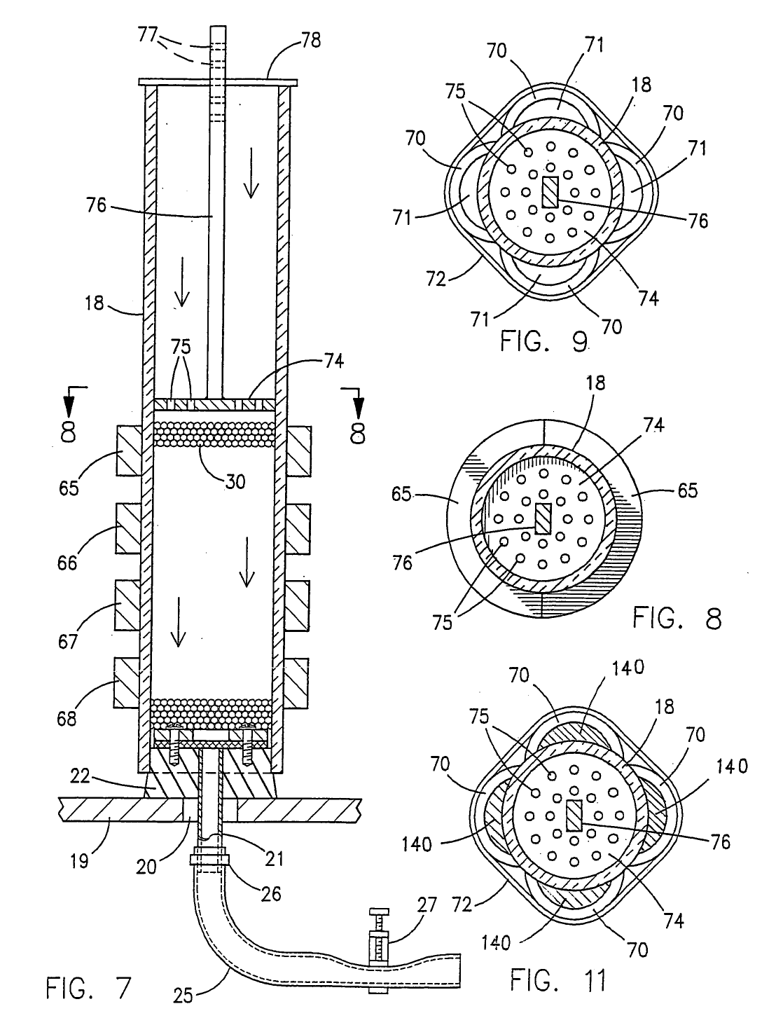

A further embodiment of apparatus of the invention for creating a magnetic field in an ion exchange resin bed is shown in FIG. 7. The ion exchange column is shown as the same column used in FIGS. 1 and 2 and is numbered similarly. In this embodiment, however, rather than an electromagnet to generate the magnetic field, the magnetic field is generated by stationary permanent magnets mounted on the ion exchange column. Four rows of permanent magnets, 65, 66, 67, and 68, are secured to ion exchange column 18 along the height of the exchange resin bed. The magnets 65-68 shown are semicircular through one half a circle so that two magnets, see magnets 65, FIG. 8, mounted end-to-end will completely surround ion exchange column 18, similarly to the magnets in the drum of FIG. 5. Other magnet sections could be used such as quarter circle sections so that four sections are needed to surround the column or third circle sections so three sections are needed to surround the column. While four vertically spaced rows of magnets are shown, additional rows could be used. For the examples that follow, magnets 65, 66, 67, and 68 were of a smaller diameter than the ion exchange column so rather than the two semicircular magnets surrounding the tube as shown in FIG. 8, four magnets per row, see magnets 70, FIG. 9, were used with the central parts of each magnet arc spaced, as shown at 71, from the column 18. The magnets may be held in position against the tube 18 by tape 72. Wooden or other non magnetic material spacers may be used to keep the rows of magnets spaced vertically along the column when just taped together as shown in FIG. 9. A wooden or plastic disc 74 with holes 75 therethrough is secured to the end of a shaft 76, a wood or plastic pole, with holes 77 therethrough and positioned in the column above the resin by a pin 78 passing through one of the holes 77. Disc 74 reduces the turbulence in the resin created by the introduction of the sample, regenerant, and rinses to the column.

### EXAMPLE 5

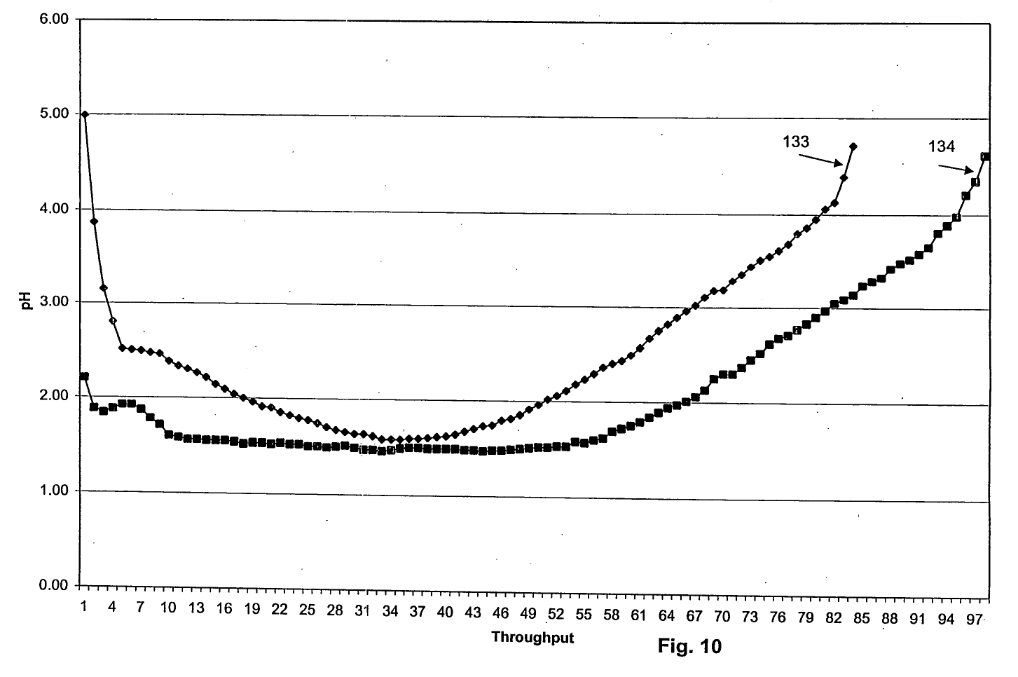

A forty eight inch long, four and three quarter inch inside diameter acrylic ion exchange column was filled about seventeen inches deep with three kilograms of Dow HCR resin. The regeneration and backwash used were scaled up to meet the requirements of the larger tube and larger amount of resin. Thus, three batches of 50.9 grams of thirty seven percent HCl each mixed with 250 grams of distilled water were used for regeneration and rinsed with three cups of distilled water. The tube was surrounded by eighteen curved heavy magnets taken from a direct current one horsepower motor. The magnets were fastened in place by tape 70 in positions as shown in FIG. 9. Wooden spacers were positioned between the rows of magnets to keep them spaced vertically along the column. Sea water was passed through the ion exchange column and the resin was considered exhausted when the pH of the sea water went above 4.5. A run of sea water through the ion exchange column without the magnets in place, but all else the same, treated between eighty three and eighty four cups of sea water before exhaustion of the resin. This is shown by line 131, FIG. 10. A run of similar sea water was made with the magnets in place and between ninety seven and ninety eight cups of sea water were treated before exhaustion of the resin. This is shown by line 132, FIG. 10. These tests resulted in about a fourteen cup increase in the ion exchange capacity of the resin. This translates to about a 16% increase in ion exchange capacity for the resin in this larger column. This also indicates that the procedure can be scaled up and should be effective for larger diameter ion exchange columns.

The above Example was conducted with the apparatus using the magnet arrangement shown in FIG. 9 with spaces 71 being air gaps. This open space 71 could easily be filled with material that would better conduct the magnetic field to the tube. FIG. 11 shows the magnet and tube arrangement of FIG. 9 with the air gaps 71 of FIG. 9 filled with a solid material 140 that can improve the conduction of the magnetic field from the magnets 70 to the tube 18. This may be a variety of materials such as a metal filled epoxy that can be poured into the gaps and solidify therein. The metal is preferably a ground cast iron. Such a material would also help hold the magnets in place. However, the material could also be a powder material. A disk or other material would preferably be placed below each set of magnets to keep the material in the gap, at least while it is curing if it is a material such as epoxy.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

1. A method of increasing the ion exchange capacity of ion exchange resin, comprising the step of applying a magnetic field to a resin bed during an ion exchange process.

2. A method of increasing the ion exchange capacity of ion exchange resin according to claim 1, wherein the step of applying a magnetic field to the resin bed during the ion exchange process comprises applying a varying magnetic field to the resin bed.

3. A method of increasing the ion exchange capacity of ion exchange resin according to claim 2, wherein the step of applying a varying magnetic field to the resin bed during the ion exchange process includes the steps of placing a coil of wire around the ion exchange column and causing a varying electrical current to flow through the coil of wire to create a varying electromagnetic field in the resin bed.

4. A method of increasing the ion exchange capacity of ion exchange resin according to claim 3, wherein the electrical current varies as a sine wave.

5. A method of increasing the ion exchange capacity of ion exchange resin according to claim 3, wherein the electrical current varies as a series of pluses.

6. A method of increasing the ion exchange capacity of ion exchange resin according to claim 3, wherein the step of applying a varying magnetic field to the resin bed during the ion exchange process additionally includes the step of providing a length of magnetic material in the resin bed to direct the magnetic field to the resin bed.

7. A method of increasing the ion exchange capacity of ion exchange resin according to claim 2, wherein the step of applying a varying magnetic field to the resin bed during the ion exchange process includes the step of moving at least one magnetic device with respect to the resin bed.

8. A method of increasing the ion exchange capacity of ion exchange resin according to claim 7, wherein the step of moving at least one magnetic device with respect to the resin bed includes the step of rotating at least one magnet around the ion exchange column and resin bed.

9. A method of increasing the ion exchange capacity of ion exchange resin according to claim 1, wherein the step of applying a magnetic field to the resin bed during the ion exchange process comprises positioning at least one stationary magnet with respect to the ion exchange column to create a magnetic field in the resin bed in the column.

10. Apparatus for carrying out an ion exchange process using an ion exchange resin with increased ion exchange capacity of the ion exchange resin, comprising:
an ion exchange column;
an ion exchange resin bed in the ion exchange column; and
at least one magnetic device for generating a magnetic field in the ion exchange resin bed.

11. Apparatus for carrying out an ion exchange process with increased ion exchange capacity of the ion exchange resin according to claim 10, wherein the at least one magnetic device is a stationary magnet located outside of the ion exchange column.

12. Apparatus for carrying out an ion exchange process with increased ion exchange capacity of the ion exchange resin according to claim 11, wherein the ion exchange column has an outside and wherein the at least one magnetic device is a plurality of stationary magnets positioned around the outside of the ion exchange column.

13. Apparatus for carrying out an ion exchange process with increased ion exchange capacity of the ion exchange resin according to claim 12, wherein the plurality of stationary magnets are positioned around the outside of the ion exchange column to form a plurality of rings around the column each including a plurality of magnets.

14. Apparatus for carrying out an ion exchange process with increased ion exchange capacity of the ion exchange resin according to claim 10, where the at least one magnetic device is a magnet positioned for rotation around the ion exchange column.

15. Apparatus for carrying out an ion exchange process with increased ion exchange capacity of the ion exchange resin according to claim 14, additionally including a housing rotatably positioned around the ion exchange column and a motor for rotating the housing, and wherein the at least one magnetic device is mounted in the housing for rotation around the ion exchange column as the housing rotates around the ion exchange column.

16. Apparatus for carrying out an ion exchange process with increased ion exchange capacity of the ion exchange resin according to claim 10, wherein the at least one magnetic device is a wire wrapped around the ion exchange column to form a wire coil around the ion exchange column adapted to carry an electrical current through the wire to create an electromagnet around the column.

17. Apparatus for carrying out an ion exchange process with increased ion exchange capacity of the ion exchange resin according to claim 16, additionally including a length of magnetic material positioned in the resin bed to direct the magnetic field to the resin bed.

18. Apparatus for carrying out an ion exchange process with increased ion exchange capacity of the ion exchange resin according to claim 17, wherein the length of magnetic material is a metal bar.

19. Apparatus for carrying out an ion exchange process with increased ion exchange capacity of the ion exchange resin according to claim 18, wherein the metal bar is cast iron with a protective surface coat thereover.

20. Apparatus for carrying out an ion exchange process with increased ion exchange capacity of the ion exchange resin according to claim 16, wherein the wire is wrapped directly around the ion exchange column.

21. Apparatus for carrying out an ion exchange process with increased ion exchange capacity of the ion exchange resin according to claim 16, additionally including an auxiliary length of tubing surrounding the ion exchange column along a length thereof including at least a portion of the resin bed, and wherein the wire is wrapped around the auxiliary tubing.

22. Apparatus for carrying out an ion exchange process with increased ion exchange capacity of the ion exchange resin according to claim 16, additionally including electrical signal generation circuitry connected to the wire coil to supply a desired electrical signal to the coil.

23. Apparatus for carrying out an ion exchange process using an ion exchange resin with increased ion exchange capacity of the ion exchange resin, comprising:
an ion exchange column;
an ion exchange resin bed in the ion exchange column; and
means for generating a magnetic field in the ion exchange resin bed.

24. Apparatus for carrying out an ion exchange process with increased ion exchange capacity of the ion exchange resin according to claim 13, wherein the ion exchange column is cylindrical with an outside diameter, wherein the plurality of stationary magnets positioned around the outside of the ion exchange column are arcuate with a smaller diameter than the outside diameter of the ion exchange column, and a gap is formed between a portion of each stationary magnet and the ion exchange column.

25. Apparatus for carrying out an ion exchange process with increased ion exchange capacity of the ion exchange resin according to claim 24, wherein the gap formed between each stationary magnet and the ion exchange column is filled with a filler material.

26. Apparatus for carrying out an ion exchange process with increased ion exchange capacity of the ion exchange resin according to claim 24, wherein the filler material is a metal filled epoxy.
